(19) United States
(12) Patent Application Publication
(10) Pub. No.: US 2007/0093233 A1
(43) Pub. Date: Apr. 26, 2007

(54) System and method for dynamic billing

(75) Inventor: Robert C. Lovell JR., Leesburg, VA (US)

Correspondence Address: PAUL, HASTINGS, JANOFSKY & WALKER LLP, P.O. BOX 919092, SAN DIEGO, CA, 92191-9092, US

(73) Assignee: Mobile 365, Inc., Chantilly, VA (US)

(21) Appl. No.: 11/585,800

(22) Filed: Oct. 25, 2006

Related U.S. Application Data
(60) Provisional application No. 60/729,762, filed on Oct. 25, 2005.

(51) Int. Cl. H04M 11/00

(52) U.S. Cl. 455/405

(57) ABSTRACT

A method and system for performing dynamic billing operations includes receiving a request message from a mobile subscriber, routing the request message for processing, performing one or more activities in accordance with the request message (included in which are various dynamic billing operations), and returning one or more response messages to the mobile subscriber.

This application claims the benefit of U.S. Provisional Patent Application No. 60/729,762, filed on Oct. 25, 2005, which is herein incorporated by reference in its entirety.

### BACKGROUND

1. Field of the Invention

The present invention relates generally to telecommunications services. More particularly, the present invention relates to the utilization of dynamic billing capabilities to augment the usefulness, applicability, etc. of various wireless messaging paradigms including, inter alia, Short Message Service (SMS) and Multimedia Message Service (MMS).

2. Background

While the ‘wireless revolution’ continues to march forward it carries with it a range of untapped, or under-exploited, potentials. As the various technological (e.g., ubiquitous cross-carrier interoperability), social (e.g., user or subscriber inertia), etc. impediments are breached, wireless data services continue to grow and continue to provide significant revenue opportunities to wireless carriers. To sustain that growth a continual stream of new ‘singular’ wireless data products and services is required.

### BRIEF SUMMARY OF THE INVENTION

The present invention facilitates such products/services by allowing a Service User (SU), e.g. a user of a mobile device such as a mobile telephone, to efficiently engage in activities or exchanges (including, possibly amongst other things, information acquisition, product purchase, etc.) with a Service Provider (SP) by addressing various of the structural impediments that naturally arise in such a model. Various of the structural impediments include:

1) Limited Resources. An SP may employ a Short Code (SC) as the address to which it would ask users of its service to direct their request messages. While the abbreviated length of an SC (e.g., five digits for a SC administered by Neustar under the Common Short Code [CSC] program) incrementally enhances the experience of an SU (e.g., the SU need remember and enter only a few digits as the destination address of their request message) it also, by definition, constrains the universe of available SCs thereby causing each individual SC to be a limited or scarce resource.

2) Billing. The need to flexibly and dynamically perform a range of billing activities (including, possibly among other things, such tasks as price determination, billing transaction, etc.) for each SU-SP interaction represent a substantial challenge.

In accordance with one aspect of the present invention, a method for dynamic billing, comprises: receiving a service request from a wireless carrier associated with a service user; extracting data elements from the service request; identifying a service associated with the service request; and performing a billing operation associated with the service request, wherein the identified service is based on a time of receipt of the service request.

According to yet another exemplary aspect of the present invention, a system for dynamic billing, comprises a messaging inter-carrier vendor communicatively linked to a wireless carrier that is associated with a mobile device of a service requestor and communicatively linked to a service provider, the messaging inter-carrier vendor configured to receive a service request from the wireless carrier, extract data elements from the service request, identify a service based on the extracted data elements, and perform a billing operation associated with the service request, wherein identification of the service is based upon a time of receipt of the service request.

In another aspect of the present invention, a method for dynamic billing associated with services offered by a service provider, comprises: receiving, at a messaging inter-carrier vendor, a service request from a wireless carrier associated with the service user; extracting a service request destination address from the service request; determining a time of receipt of the service request; identifying a service associated with the service request based on the time of receipt and the service request destination address; and performing a billing operation associated with the service request, the billing operation including a price for the requested service.

These and other features of embodiments of the present invention will be more fully explained below in conjunction with the drawings.

### BRIEF DESCRIPTION OF THE DRAWINGS

FIG. 1 is a diagrammatic presentation of an exemplary user experience that may be realized through the instant invention.

FIG. 2 is a schematic diagram illustrating the relative locations of a messaging Inter-Carrier Vendor (ICV), Wireless Carriers (WCs), and SPs, in accordance with embodiments of the instant invention.

FIG. 3 illustrates several of the price determination mechanisms that may be possible through the instant invention.

FIG. 4 illustrates additional price determination mechanisms that may be possible through the instant invention.

### DETAILED DESCRIPTION OF THE INVENTION

The following hypothetical example is presented to better convey the particulars of the present invention.

In this example, Alice is a potential SU who desires to utilize a service that is offered by a SP (to, possibly among other things, obtain some requested information, download a ringtone, purchase a product, etc.).

Alice uses her mobile telephone to compose a (SMS, MMS, etc.) ‘request’ message that is directed to a destination address (e.g., a SC) as provided or specified by the SP. Following the successful receipt and processing of Alice's request message (described in detail below), Alice receives from the SP one or more ‘response’ messages.

The response messages may contain, possibly among other material, the requested information, the requested ringtone, the confirmation of a purchase of a product, SP-provided or third-party supplied descriptive text, SP-provided or third-party supplied advertising, images, sounds, etc.

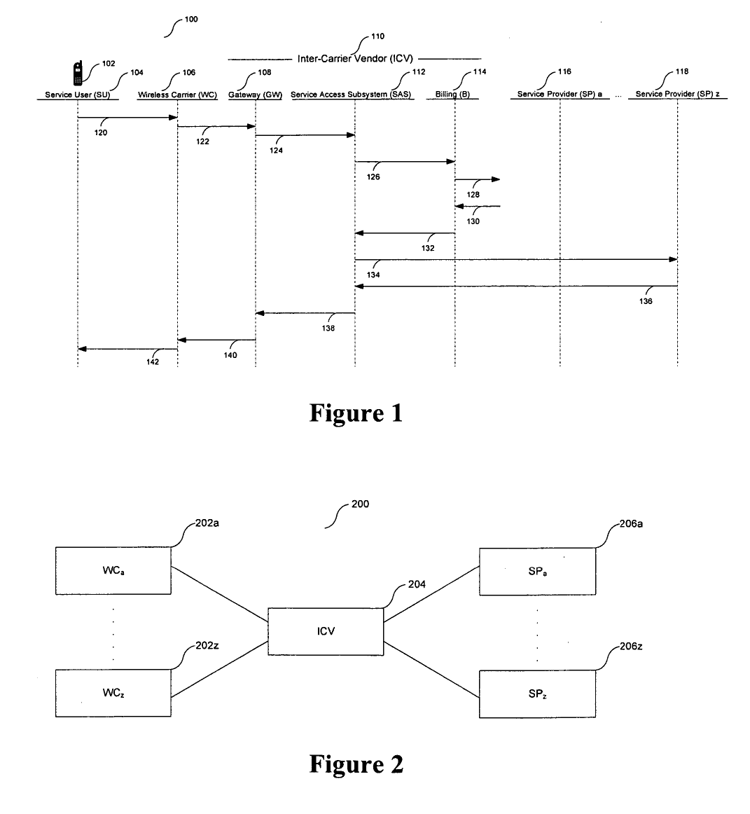

The hypothetical example presented above may be better and more fully understood through the following discussion of FIG. 1. Notably, in the discussion to follow, reference is made to messages that are sent, for example, between a mobile telephone user (Alice) and an SP. As set forth below, a given “message” sent between Alice and an SP may actually comprise a series of steps in which the message is received, forwarded and routed between different entities, including a mobile phone associated with Alice, a WC, an ICV, and a SP. Thus, unless otherwise indicated, it will be understood that reference to a particular message, such as, for example, a request message, generally includes that particular message as conveyed at any stage between an origination source, such as Alice's mobile phone, and an end receiver, such as an SP. As such, reference to a particular message generally includes a series of related communications between, for example, Alice and a WC, the WC and an ICV, and the ICV and an SP. The series of related communications may, in general, contain substantially the same information, or information may be added or subtracted in different communications that nevertheless may be generally referred to as a same message. To aid in clarity, a particular message, whether undergoing changes or not, is referred to by different reference numbers at different stages between a source and an endpoint of the message.

FIG. 1 illustrates aspects of an exemplary service user experience, in accordance with embodiments of the present invention. An SP (SPa 116 . . . SPz 118) desires to offer a product or a service to a potential SU 104. For convenience to the potential SU 104 the SP, for example SPz 118 in the narrative that follows, employs a single SC, e.g. 12345, as a request message destination address and advertises that SC. The SP 118 also pays to register SC 12345 as a CSC, so that SC 12345 is available (e.g., properly routed) by all WCs. A description of a common (i.e., universal) short code environment may be found in pending U.S. patent application Ser. No. 10/742,764 entitled “UNIVERSAL SHORT CODE ADMINISTRATION FACILITY.”

As the SP 118 makes available further products and/or services it would prefer (for reasons of expense, complication of the SU user experience, etc.) to not have to repeat the process that was described above—select a SC, pay to register the SC as a CSC, advertise the SC, etc.—for each new product and/or service. By employing elements of the instant invention (and utilizing key aspects of same, as described in detail below) the SP 118 need not repeat the process.

It is important to note that while the discussion that was presented above focused on the use of SCs, it will be readily apparent to one of ordinary skill in the relevant art that Telephone Numbers (TNs) and other message address identifiers are equally applicable and, indeed, are fully within the scope of the present invention.

Alice, our potential SU 104, composes on her mobile telephone 102 a request SMS message 120, and dispatches the request SMS message 120.

It is important to note that while the action that was just described focused on the use of SMS, it will be readily apparent to one of ordinary skill in the relevant art that other wireless messaging paradigms, such as inter alia MMS, are equally applicable and indeed are fully within the scope of the present invention. To simplify the description that follows an SMS-based model will be employed.

As identified (advertised and publicized) by the SP 118, Alice may address (direct) her request SMS message 120 to a TN. For example, 703-555-1234. Alternatively, Alice may address (direct) her request SMS message 120 to a SC. For example, 12345. It will be readily apparent to one of ordinary skill in the relevant art that other message address identifiers are equally applicable and indeed are fully within the scope of the present invention. To simplify the description that follows, an SC-based model will be employed.

Alice's WC 106 receives Alice's request SMS message 120, examines the destination address (e.g., the SC, perhaps 12345), identifies the destination address as residing outside of its network, and passes the request message 122 along to its messaging ICV 110 for processing.

Reference is made to pending U.S. patent application Ser. No. 10/426,662, entitled “AN INTERMEDIARY NETWORK SYSTEM AND METHOD FOR FACILITATING MESSAGE EXCHANGE BETWEEM WIRELESS NETWORKS,” for a description of a messaging ICV, such as messaging ICV 110, and a summary of various of the services/functions/etc. that are performed by same.

The use of messaging ICV 110, although not required, provides significant advantages. As shown, for example, in FIG. 2, a messaging ICV 204 (e.g., messaging ICV 110 from FIG. 1) is disposed between multiple WCs 202a . . . 202z (e.g., including WC 106 from FIG. 1) on one side and multiple SPs 206a . . . 206z (e.g., including SP 118 from FIG. 1) on the other side. Consequently, as long as messaging ICV 110 from FIG. 1 has a relationship with Alice's particular WC (WC 106 from FIG. 1) then Alice will be able to obtain access to the universe of products and service offerings that are exposed by the various SPs that maintain a relationship with the messaging ICV 110.

Returning to FIG. 1, a Gateway (GW) 108 within the messaging ICV 110 receives the request message 122, examines the destination address (i.e., the SC, perhaps 12345), determines that the message should be processed by a Service Access Subsystem (SAS) 112, and appropriately routes the message 124.

The SAS 112, operating as a single channel/interface within the messaging ICV 110 to multiple SPs (e.g., SPa 116 . . . SPz 118), receives Alice's request SMS message 124 and, possibly among other activities, extracts key data elements (e.g., Alice's TN as the source address of the message, the destination address [e.g., the SC, perhaps 12345] of the message, etc.) from the message and completes various processing tasks.

One of the processing tasks that the SAS 112 may complete is a source WC determination operation. For example, by comparing Alice's TN (as the source address of the message) against an authoritative body of TN-to-WC mapping data (which takes into account, possibly among other things, number pooling and number porting events), the identity of Alice's WC may be ascertained. Alternatively, the identity of Alice's WC may be derived from the specific path/channel/etc. that Alice's request message 124 was received. Other source WC identity determination mechanisms will be readily apparent to those of ordinary skill in the relevant art.

One of the processing tasks that the SAS 112 may complete is a pricing determination operation (for example, determining from possibly a broad range of parameters the specific price that Alice will be charged for her use of the requested service). The price determination mechanism may include any number or combination of available data elements.

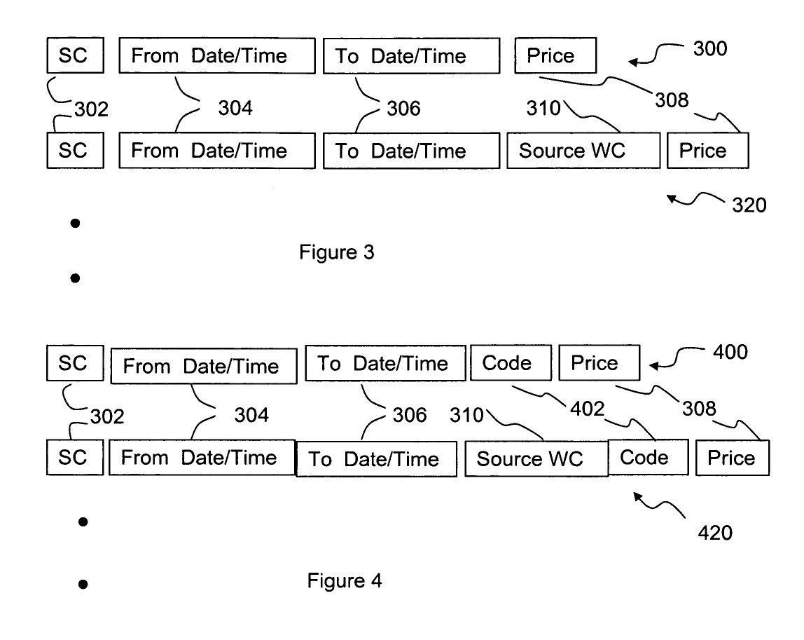

FIG. 3 provides an illustration of exemplary elements that can used in a price determination mechanism in accordance with embodiments of the present invention. The first example in FIG. 3 illustrates a mechanism 300 where a single SC 302 may be used for different purposes between different From and To dates and times—i.e., SC 302 may be used by an SP for a first service during one From-To date/time range, used for a second service during a second From-To date/time range and used for a third service during a third From-To date/time range, etc. For example, an ICV SAS, such as SAS 112 might use mechanism 300 to determine that a request for service corresponds to a second service, based on the determination of the content of ‘From Date/Time’ element 304, and ‘To Date/Time’ element 306. In other words, an ICV SAS can receive a service request message at a given time and given date. The SAS determines that the given time and given date fall within a To-From range indicated in elements 304 and 306 that corresponds to a second service. Accordingly, the value determined in ‘Price’ element 308 would correspond to a price associated with the cost of the second service. At another time, the ICV SAS (or other price-determining entity) might determine based on elements 304, 306 that the service request corresponds to a third service. Price element 308 would then be adjusted in accordance with the cost of the third service.

The second example in FIG. 3 illustrates a pricing mechanism 320 that further qualifies the price selection by use of a ‘source WC’ element 310. Thus, SAS 112 could use information from elements, 304, 306 and ‘source WC’ element 310 to determine the value of ‘Price’ element 308. For example, for any given From-To date/time range the price charged to a service user who subscribes to WCa might be different than a price charged to a service user who subscribes to a different wireless carrier, such as WCz. Additionally, the price differential between subscribers to two different WCs could vary with the specific date/time values in elements 304, 306. For example, for some From-To date/time ranges, a subscriber to a first WC pays a higher price (than a subscriber to a second WC) for a service associated with that range, while for another From-To date/time range, the subscriber to the first WC pays a lower price for a service associated with the other From-To date/time range. In sum, according to one embodiment of the present invention, an inter-carrier vendor determines a service associated with a service request by determining a destination address of the service request, determining a time of receipt of the service request, comparing the time of receipt against a predetermined time range, and identifying the requested service based on the destination address and the time of receipt.

According to different aspects of the present invention, in some cases, the identifying of the requested service is tantamount to determining the price of the service. In other words, based on the destination and time information, for example, a service is identified that has a fixed price regardless of when the service request is received (so long as the time of receipt corresponds to a time in which that service is offered according to the destination address). In other cases, a particular service could be offered over a series of time ranges, in which receipt of the service request at any one of the series of time ranges could serve to identify the same service. However, in the latter case, the cost of the service might vary between time ranges. Thus, the From-to date/time range extracted might serve to both identify the service and to determine its (non-unique) price. Other arrangements will be readily apparent to those of ordinary skill in the relevant art.

Alternatively, the price determination mechanism may include a code or identifier that is extracted directly from the body or payload of the request message, or derived indirectly from any number of available data elements.

FIG. 4 provides an illustration of several elements involved in a price determination mechanism according to other embodiments of the present invention. Mechanism 400 in FIG. 4 could also be employed where a single SC may be used for different purposes between different From and To dates and times—i.e., a SC may be used by a SP for a first service during one From-To date/time range, used for a second service during a second From-To date/time range, and used for a third service during a third From-To date/time range, etc., in combination with different codes 402. Thus, as SAS, such as SAS 112 could use both From-To date/time information associated with elements 304 and 306, as well as code information 402, that could be extracted from a request message, to determine the price associated with the requested service. Mechanism 420 in FIG. 4 further provides that, in addition to depending on From-To date/time range information in 304 and 306 and code information 402, the determined price 308 for a requested service can be modified according to the source WC 310 that is associated with the user requesting the service, as discussed above with respect to FIG. 3. Other arrangements will be readily apparent to those of ordinary skill in the relevant art.

Additionally, further constraints or discriminators (elements)—including for example time-of-day, day-of-week, physical location (as derived from a Location Based Service [LBS] facility), etc.—may be included in the price determination mechanism.

The price determination mechanisms presented above are illustrative only. It will be readily apparent to one of ordinary skill in the relevant art that numerous other price determination mechanisms are easily possible.

Another of the processing tasks that the SAS 112 may complete is the passing 126 of all of the extracted/derived/retrieved/etc. information to its Billing (B) interface 114 to complete a billing transaction 128.

The billing transaction 128 may take any number of forms and may involve different external entities (e.g., a carrier billing system gateway provider, a credit or debit card clearinghouse, etc.). The billing transaction 128 may include, inter alia:

1) The appearance of a line item charge on the bill or statement that Alice receives from her WC 106. Exemplary mechanics and logistics associated with this approach are described in pending U.S. patent application Ser. No. 10/837,695 entitled “SYSTEM AND METHOD FOR BILLING AUGMENTATION.” Other ways of completing or performing line item billing are easily implemented by those skilled in the art.

2) The charging of a credit card or the debiting of a debit card. The particulars (e.g., number, expiration date) of the card that is to be used may, as one example, have been provided by Alice in her request SMS message 124.

3) Other means including, inter alia, pre-paid or ‘countdown’ cards, redemption coupons, etc.

Following the successful completion 130/132 of the billing transaction 128 the SAS 112 may dispatch a message (a transaction summary message) 134 to the destination/recipient SP (118 in the instant example). The transaction summary that is selected from a pool of available informational text based on the current physical location of the recipient of the message as derived from, as one example, a LBS facility).

The response message(s) may optionally contain advertising—e.g., textual material if an SMS model is being utilized, or multimedia (images of brand logos, sound, video snippets, etc.) material if an MMS model is being utilized. The advertising material may be selected statically (e.g., all generated messages are injected with the same advertising material), randomly (e.g., a generated message is injected with advertising material that is randomly selected from a pool of available material), or location-based (i.e., a generated message is injected with advertising material that is selected from a pool of available material based on the current physical location of the recipient of the message as derived from, as one example, a LBS facility).

The response message(s) may optionally contain promotional materials (e.g., still images, video clips, etc.).

It is important to note that the hypothetical example that was presented above, which was described in the narrative and which was illustrated in the accompanying figures, is exemplary only. It will be readily apparent to one of ordinary skill in the relevant art that numerous alternatives to the presented example are easily possible and, indeed, are fully within the scope of the present invention.

The discussion that was just presented employed two specific wireless messaging paradigms—SMS and MMS. These paradigms potentially offer an incremental advantage over other paradigms in that native support for SMS and/or message 134 may contain, possibly among other items, identifying information for Alice (e.g., source TN, source WC, etc.), the destination address (e.g., SC, TN, etc.) of Alice's request message, the particulars of the completed billing transaction, etc.

The SP 118 may dispatch a response message to Alice's mobile telephone 102, either directly or indirectly, containing (possibly among other things that may be applicable to or appropriate for the service that was requested by Alice) requested information, a requested ringtone, the confirmation of a purchase of a product, etc.

Under an indirect route, the response message may travel from the SP 118 to the SAS 112 (as message 136) and then to the Gateway 108 (as message 138) and then to the WC (as message 140) and then to Alice's mobile telephone 102 (as message 142).

Under a direct route, the response message may travel from the SP 118 directly to the Gateway 108 (as a message that is not explicitly depicted in FIG. 1) and then to the WC (as message 140) and then to Alice's mobile telephone 102 (as message 142).

The SP 118 may dispatch multiple response messages using any combination of direct and/or indirect routes.

The response message(s) may optionally contain an informational element—e.g., ‘Thank you for using our service!’, etc. The informational element may be selected statically (e.g., all generated messages are injected with the same informational text), randomly (e.g., a generated message is injected with informational text that is randomly selected from a pool of available informational text), or location-based (i.e., a generated message is injected with informational text MMS is commonly found on the mobile telephone that a potential SU would be carrying. However, it is to be understood that it would be readily apparent to one of ordinary skill in the relevant art that other paradigms are fully within the scope of the present invention.

The following list defines acronyms as used in this disclosure.

| Acronym | Meaning |
|---|---|
| CSC | Common Short Code |
| GW | Gateway |
| ICV | Inter-Carrier Vendor |
| LBS | Location Based Service |
| MMS | Multimedia Message Service |
| SAS | Service Access Subsystem |
| SC | Short Code |
| SMS | Short Message Service |
| SP | Service Provider |
| SU | Service User |
| TN | Telephone Number |
| WC | Wireless Carrier |

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for dynamic billing, comprising:
receiving a service request from a wireless carrier associated with a service user;
extracting data elements from the service request;
identifying a service associated with the service request; and
performing a billing operation associated with the service request, wherein the identified service is based on a time of receipt of the service request.

2. The method of claim 1, further comprising determining a price for the service request based on the identified service.

3. The method of claim 1, wherein the service request is received at a messaging inter-carrier vendor.

4. The method of claim 1, wherein the service request is one of an MMS message and an SMS message.

5. The method of claim 1, wherein the data elements include one or more of a request message destination address, a telephone number of a wireless device associated with the service user, and an identifier of the wireless carrier.

6. The method of claim 5, wherein the request message destination address is a short code or a telephone number.

7. The method of claim 1, further comprising determining an identity of the wireless carrier.

8. The method of claim 6, wherein the determining an identity comprises one of comparing a telephone number of a wireless device from which the service request is received against an authoritative body of telephone number-wireless carrier mapping data and determining a specific path/channel through which the request message is received.

9. The method of claim 7, wherein a price associated with the service request is based on the identity of the wireless carrier and based on the determined service.

10. The method of claim 1, wherein a price billed for the service request is based on a code that is extracted from the request message or that is derived indirectly from the data elements.

11. The method of claim 3, further comprising:
sending a transaction summary from the messaging inter-carrier to a service provider identified by the service request; and
sending a response message to the service user from the messaging inter-carrier vendor.

12. A system for dynamic billing, comprising a messaging inter-carrier vendor communicatively linked to a wireless carrier that is associated with a mobile device of a service requestor and communicatively linked to a service provider, the messaging inter-carrier vendor configured to:
receive a service request from the wireless carrier:
extract data elements from the service request;
identify a service based on the extracted data elements; and
perform a billing operation associated with the service request, wherein identification of the service is based upon a time of receipt of the service request.

13. The system of claim 12, wherein the data elements comprise one or more of a request message destination address, a telephone number of a wireless device associated with the service user, and an identifier of the wireless carrier.

14. The system of claim 13, wherein the request message destination address is a short code or a telephone number.

15. The system of claim 12, wherein the service request is one of an MMS message and an SMS message.

16. The system of claim 13, wherein the messaging inter-carrier vendor comprises:
a gateway configured to receive the service request from the wireless carrier and forward the service request based on the request message destination address;
a service access subsystem configured to extract the data elements and to forward transaction information to the service provider;
and a billing interface configured to perform the billing operation.

17. The system of claim 12, wherein the billing operation comprises charging a price for the requested service, and wherein the price is determined based on the identification of the requested service and one or more of an identity of the wireless carrier and a code that is extracted from the request message or that is derived indirectly from the data elements.

18. A method for dynamic billing associated with services offered by a service provider, comprising:
receiving, at a messaging inter-carrier vendor, a service request from a wireless carrier associated with the service user;
extracting a service request destination address from the service request;
determining a time of receipt of the service request;
identifying a service associated with the service request based on the time of receipt and the service request destination address; and
performing a billing operation associated with the service request, the billing operation including a price for the requested service.

19. The method of claim 18, wherein the price of the requested service is uniform over time.

20. The method of claim 18, wherein the price of the requested service varies in accordance with preconfigured time ranges.

21. The method of claim 18, further comprising identifying the wireless carrier based on information in the service request, wherein the price for the service request is based on the identified wireless carrier.

22. The method of claim 18, further comprising extracting code information from the service request, wherein the price for the service request is based on the code information
